(19) United States
(12) Patent Application Publication
(10) Pub. No.: US 2012/0078864 A1
(43) Pub. Date: Mar. 29, 2012

(54) ELECTRONIC DATA INTEGRITY PROTECTION DEVICE AND METHOD AND DATA MONITORING SYSTEM

(75) Inventors: Ji LI, Beijing (CN); Izuru Kitamura, Beijing (CN)

(73) Assignee: Sony Corporation, Tokyo (JP)

(21) Appl. No.: 13/246,231

(22) Filed: Sep. 27, 2011

(30) Foreign Application Priority Data
Sep. 27, 2010 (CN) 201010298476.X

(51) Int. Cl. G06F 17/30

(52) U.S. Cl. 707/702; 707/E17.007

(57) ABSTRACT

The present invention discloses an electronic data integrity protection device and method and a data monitoring system, wherein the device includes: a data reception unit configured to receive electronic data; a signal reception unit configured to receive an external signal; a signal processing unit configured to process the external signal in accordance with a predetermined integrity protection strategy, to output a corresponding instruction, wherein the integrity protection strategy specifies at least an integrity protection mode associated with the external signal; and an integrity protection operation unit configured to perform, in response to the instruction, integrity protection operation on the electronic data so as to generate integrity protection information. According to the technical solution of the invention, it is possible to provide appropriate integrity protection for data when an external signal occurs, realize event-driven integrity and achieve a good balance among security, resource consumption and efficiency.

### FIELD OF THE INVENTION

The present invention relates to the field of electronic information processing and in particular to an electronic data integrity protection device and method and a data monitoring system.

### BACKGROUND OF THE INVENTION

Electronic data, e.g., an image, a text, an audio, a video, etc., is susceptible to falsification as opposed to paper media. In various applications, a user has to verify electronic data for integrity to confirm that the electronic data is not illegally falsified. Like paper media, electronic data can act as an item of forensic evidence due to promulgation of laws and regulations including Electronic Signature Law, etc. It is highly desired to ensure that electronic data is free from falsification and is authentic and reliable. Existing electronic data integrity protection methods generally adopt a digital digest, a timestamp, a digital signature, a digital watermark or the like. The existing electronic data integrity protection methods will be described below taking a video as an example.

The existing video integrity protection methods are mainly concerned with integrity protection methods in two application scenarios, in one of which integrity of video data in transmission is protected. In transmission, the video data may be lost or falsified. Transmission integrity may be detected by comparing a digital digest prior to transmission with that after transmission. Firstly a sender calculates a digital digest of transmission data to be transmitted, and the digital digest typically is transmitted in a following data packet. A receiver calculates a digital digest in the same method upon reception of the data and compares it with the digital digest calculated by the sender to thereby detect any modification to the data. Furthermore, a video data integrity detection method and system is provided in Chinese Patent Application No. CN200810247456.2 entitled “Stored Video Data Integrity Detection Method and System”, for example. Feature values are calculated for respective sets of I frames generated by a video encoder prior to transmission, and again feature values are calculated for the received respective sets of I frames after transmission. The feature values prior to transmission are compared with those after transmission to detect transmission integrity. In this method, integrity of stored video data is detected by comparing the feature values of the respective sets of I frames generated by the video encoder prior to transmission with those of the respective sets of I frames after transmission. This method enables integrity protection of video data in transmission.

In the other application scenario, integrity of video in storage is protected. A digital signature, a digital watermark, etc., can be adopted to ensure security of video data in storage. A digital digest of the video data is signed or a digital watermark is embedded in the video data, and if the video data is falsified, then it can not be verified with the digital signature or the digital watermark. Furthermore, a hash link is frequently used to enhance protection of data integrity, that is, a hash value of each block of data will be used to calculate a hash value of the next block of data and a hash value of the last block of data will become a final hash value. Besides the link structure, employing a hash tree is also an important method. A hash value of each block of data acts as a leaf node of a tree, and the value of the leaf node acts as an input from which a hash value is calculated to obtain the value of its parent node, and so on until the value of the root node is calculated. The hash value of the last block of data in the hash link or the value of the root node in the hash tree is digitally signed, and the integrity of the data may be judged by verifying the resulting digital signature. Alternatively, a timestamp may be appended and verified to judge any modification to the data since the timestamp is appended.

In the method for calculating or verifying integrity of video data in a hash link, if a hash value corresponding to a block of data is lost, then multiple blocks of hashed data in the hash link will lose their function of protecting data integrity. Redundant hash links are adopted to solve this problem, i.e., a method of adopting multiple hash links is generally proposed, in which a hash value of a segment of video data appears redundantly in different hash links. Thus, availability of the hash value is ensured with a high probability. However, redundancy of data amount exists in this method.

Typically in the existing data integrity methods, the requirement for scene change has not been taken into account, and only the same protection method is always adopted. However, the integrity requirements in different scenes are not totally the same. For example, in video monitoring, the requirement in the daytime is different from that in the nighttime; the requirement for indoors is different from that for outdoors, etc. With the same protection method, sufficient protection may be impossible or resources of computation or storage may be wasted due to excessive protection.

In an existing real-time data monitoring system, e.g., a video monitoring system, a video saved upon occurrence of an abnormal condition can be used to ascertain a reason of the abnormal condition or used as evidence, and it is significant to protect integrity of existing data. In the existing video monitoring system, there is a process trigged by alarming, e.g. alarming a user over a network in a timely way, starting another device or the like. Such process trigged by alarming in a monitoring and alarming network system has been specified in General Technical Standard of City Area Monitoring and Alarming Network System, GA/T669-2006. However, in the prior art, the process trigged by alarming does not include a video data integrity protection process. The optimum chance of data protection will be lost when integrity protection is enhanced for video data after the user receives an alarming signal over the network. Particularly in the prior art, a specific requirement for the process trigged by alarming in the monitoring system has not bee taken into account, and there is a lack of a method for enhancing video data integrity protection in response to an alarming signal. Important data has to be protected in a timely and rapid way when the alarming signal is issued. Also, when the system tends to be subject to an abnormality or an attack, integrity protection of video data has to be enhanced. In a transmission system over which data is prone to a loss, data integrity is ensured by introducing redundant backup of feature values. However, the introduction of the redundant backup may result in a waste of a system resource in a normal case that no alarming signal is generated.

As described above, the technical solutions in the prior art generally have the following drawbacks: the degree of protection can not be varied as application scene changes in the existing data integrity protection methods, and the existing process trigged by alarming does include a triggered protection of data integrity.

### SUMMARY OF THE INVENTION

Summary of the invention will be given below to provide basic understanding of some aspects of the invention. It shall be appreciated that this summary is neither exhaustively descriptive of the invention nor intended to define essential or important parts or the scope of the invention, but is merely for the purpose of presenting some concepts in a simplified form and hereby acts as a preamble of detailed description which will be discussed later.

In view of the above circumstances in the prior art, an object of the invention is to provide an electronic data integrity protection device which can solve or alleviate one or more of the technical problems in the prior art.

In order to achieve the above object, according to an aspect of the invention, there is provided an electronic data integrity protection device including: a data reception unit configured to receive electronic data to be protected; a signal reception unit configured to receive an external signal; a signal processing unit configured to process the external signal received by the signal reception unit in accordance with a predetermined integrity protection strategy, to output a corresponding instruction, wherein the integrity protection strategy specifies at least an integrity protection mode associated with the external signal; and an integrity protection operation unit configured to perform, in response to the instruction output by the signal processing unit, a corresponding integrity protection operation on the electronic data received by the data reception unit, according to the integrity protection mode associated with the external signal, so as to generate integrity protection information of the electronic data.

According to another aspect of the invention, there is further provided an electronic data integrity protection method including: receiving electronic data to be protected; receiving an external signal; processing the external signal in accordance with a predetermined integrity protection strategy, to output a corresponding instruction, wherein the integrity protection strategy specifies at least an integrity protection mode associated with the external signal; and performing, in response to the instruction, a corresponding integrity protection operation on the electronic data, according to the integrity protection mode associated with the external signal, so as to generate integrity protection information of the electronic data.

According to another aspect of the invention, there is further provided a data monitoring system including: a data capturing device configured to capture electronic data to be protected; a control center configured to send a control signal used to initiate or enhance electronic data integrity protection; an electronic data integrity protection device configured to initiate or enhance, in response to the control signal, electronic data integrity protection for the electronic data, wherein the electronic data integrity protection device comprises a data reception unit configured to receive the electronic data, a signal reception unit configured to receive the control signal, a signal processing unit configured to process the control signal in accordance with a predetermined integrity protection strategy, to output a corresponding instruction, wherein the integrity protection strategy specifies at least an integrity protection mode associated with the control signal, and an integrity protection operation unit configured to perform, in response to the instruction output by the signal processing unit, a corresponding integrity protection operation on the electronic data, according to the integrity protection mode associated with the control signal, so as to generate integrity protection information of the electronic data.

According to another aspect of the invention, there is further provided a computer program product for performing the above electronic data integrity protection method.

According to another aspect of the invention, there is further provided a computer readable medium on which computer program codes for performing the above electronic data integrity protection method are recorded.

According to the technical solution of the invention, it is possible to provide appropriate integrity protection for data according to a predetermined integrity protection strategy when an external signal such as an alarming signal, a scene change signal, etc., occurs, to thereby achieve a good tradeoff among security, resource consumption and efficiency.

### BRIEF DESCRIPTION OF THE DRAWINGS

The invention can be better understood with reference to the description given below in conjunction with the accompanying drawings, throughout which identical or like components are denoted by identical or like reference signs, and together with which the following detailed description are incorporated into and form a part of the specification and serve to further illustrate preferred embodiments of the invention and to explain principles and advantages of the invention. In the drawings:

FIG. 1 illustrates a typical environment in which the invention is applied;

FIG. 2 illustrates a block diagram of an electronic data integrity protection device according to an embodiment of the invention;

FIG. 3 illustrates a schematic diagram of a hierarchy of video data;

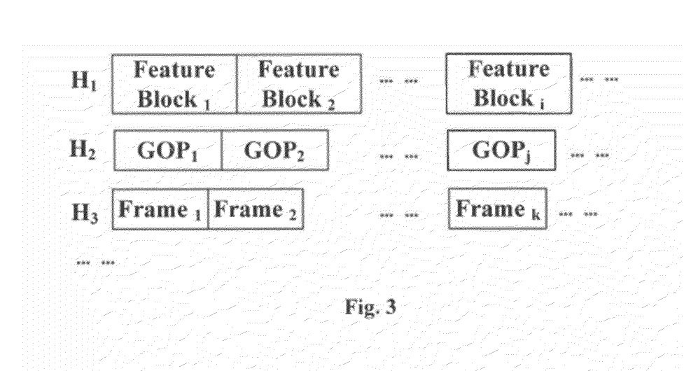

FIG. 4 illustrates a schematic diagram of block-wise iterative calculation on video data;

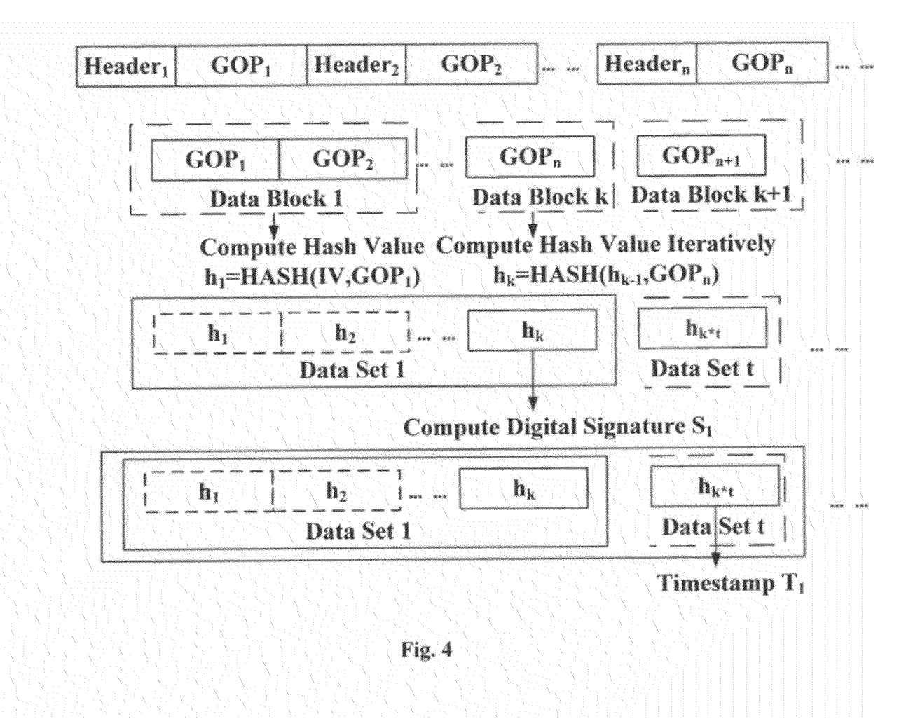

FIG. 5 illustrates a first online way in which the electronic data integrity protection device according to the embodiment of the invention is applied in a video monitoring system;

FIG. 6 illustrates a second centralized processing way in which the electronic data integrity protection device according to the embodiment of the invention is applied in a video monitoring system;

FIG. 7 illustrates a third offline way in which the electronic data integrity protection device according to the embodiment of the invention is applied in a video monitoring system;

FIG. 8 illustrates a general flow chart of an electronic data integrity protection method according to an embodiment of the invention; and

FIG. 9 is a block diagram illustrating an exemplary construction of a computer in which the invention may be implemented.

Those skilled in the art will appreciate that elements in the drawings are illustrated merely for simplicity and clarity and have not necessarily been drawn to scale. For example, dimensions of some of the elements in the drawings may have been enlarged relative to other elements to facilitate understanding of the embodiments of the present invention.

### DETAILED DESCRIPTION OF THE INVENTION

Exemplary embodiments of the present invention will be described below in conjunction with the accompanying drawings. For the sake of clarity and conciseness, not all the features of practical implementations have been described in the specification. However it shall be appreciated that during developing any of such practical implementations, numerous implementation-specific decisions shall be made to achieve the developer's specific goals, for example, to comply with those system- and business-related constraining conditions which will vary from one implementation to another. Moreover it shall also be appreciated that such a development effort might be very complex and time-consuming but may simply be a routine task for those skilled in the art benefiting from this disclosure.

It shall further be noted that only those device structures and/or process steps closely relevant to the solutions of the invention will be illustrated in the drawings while other details less relevant to the invention are omitted so as not to obscure the invention due to those unnecessary details.

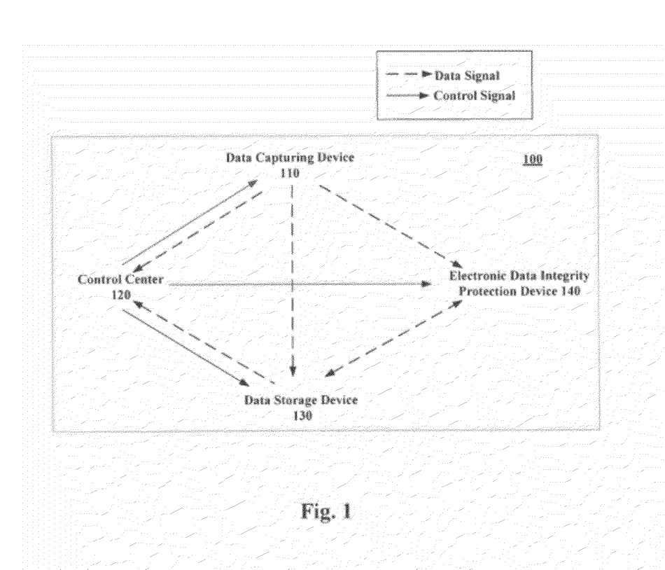

Firstly, a typical environment in which the invention is applied will be introduced with reference to the drawings. FIG. 1 illustrates a typical environment in which the invention is applied, i.e., a data monitoring system, such as a video monitoring system, etc. However, those skilled in the art shall appreciate that the invention will not be limited to the application environment illustrated in FIG. 1.

As illustrated in FIG. 1, the data monitoring system 100 includes a data capturing device 110, a control center 120, a data storage device 130 (optional) and an electronic data integrity protection device 140.

The data capturing device 110 may capture electronic data to be protected and transmit the captured electronic data to the data storage device 130 so as to be stored therein or directly to the control center 120 and the electronic data integrity protection device 140. Herein, the electronic data may include, but not limited to, audio, video, image, text, etc.

The control center 120 may send a control signal to the electronic data integrity protection device 140 to initiate or enhance electronic data integrity protection (which is referred to as an “external signal” relative to the electronic data integrity protection device 140). Herein, the signal may include, but not limited to, an abnormality alarming signal, a scene change signal, a specific timing signal, a user-triggered signal, etc. For example, the signal may be a user-triggered signal, e.g., a user-initiated initialization signal upon initialization, etc.; a signal transmitted automatically according to a scene or an environment, e.g., change of a monitoring scene from the daytime to the nighttime or from a working day to a weekend; or various abnormality alarming signals, e.g., an abnormality alarming signal transmitted upon detection of a suspicious object, a suspicious behavior of a passerby, abnormal driving of a vehicle, etc., in the video monitoring system.

In response to the control signal, the electronic data integrity protection device 140 may initiate or enhance electronic data integrity protection for the data acquired directly from the data capturing device 110 or retrieved from the data storage unit 130 so as to achieve a tradeoff between security and protection cost.

An electronic data integrity protection device according to an embodiment of the invention will be described in details below with reference to the drawings.

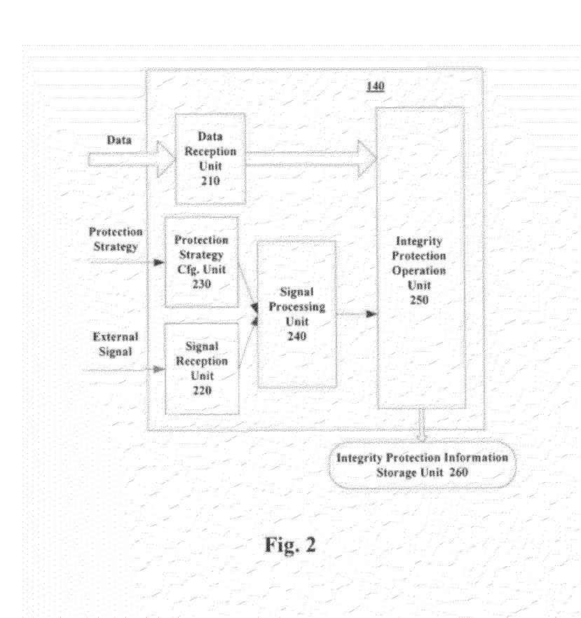

FIG. 2 illustrates a structural block diagram of the electronic data integrity protection device according to an embodiment of the invention. As illustrated in FIG. 2, the electronic data integrity protection device 140 according to the embodiment of the invention includes a data reception unit 210, a signal reception unit 220, a protection strategy configuration unit 230 (optional), a signal processing unit 240 and an integrity protection operation unit 250.

Particularly, the data reception unit 210 may be configured to receive electronic data to be protected, and the signal reception unit 220 may be configured to receive an external signal.

The protection strategy configuration unit 230 may be configured to, for example, enable a user to configure an integrity protection strategy, where the integrity protection strategy specifies at least an integrity protection mode associated with the external signal (the integrity protection mode will be further described later), so that different integrity protection modes may be adopted for different external signals. Furthermore, the integrity protection strategy may also specify whether to perform integrity protection when there is no external signal and a specific integrity protection mode when the integrity protection is performed. It shall be appreciated that the integrity protection strategy may alternatively be preset in the electronic data integrity protection device 140 without being configured by a user, and in this case the protection strategy configuration unit 230 may be omitted.

The signal processing unit 240 may be configured to process the external signal received by the signal reception unit 220 in accordance with the predetermined integrity protection strategy, for example, configured by the protection strategy configuration unit 230 to output a corresponding instruction indicating the integrity protection mode associated with the received external signal.

The integrity protection operation unit 250 may be configured to perform, in response to the instruction output from the signal processing unit 240, a corresponding integrity protection operation on the electronic data received by the data reception unit 210 according to the integrity protection mode associated with the external signal to generate integrity protection information of the electronic data. Herein, the integrity protection operation may include, but not limited to, digital watermark, digital digest, digital signature, timestamp, etc.

Thus, fore example, initiation of data integrity protection may be triggered by the external signal in the case that data integrity protection is not initiated, or enhanced data integrity protection may be triggered by the external signal in the case that data integrity protection has been initiated according to a specific integrity protection strategy. Furthermore, in a specific implementation, a cancel signal may also be set to disable an integrity protection mechanism or return an enhanced integrity protection mechanism to a normal protection mechanism. The cancel signal may be user-triggered, for example, the cancel signal is initiated when a user decides to return the protection mechanism from an enhanced one to a normal one so as to recover the integrity protection mechanism. For example, the user may also set a specific cancel condition for a cancel signal so that the cancel signal will be initiated automatically when the cancel condition is satisfied. For example, a signal for enhancing integrity protection is initiated upon detection of a suspicious object, and a cancel signal is initiated automatically after a certain period of time since the suspicious object is cleared.

Furthermore, an integrity protection information storage unit 260 may be configured to store the integrity protection information generated by the integrity protection operation unit 250. Although the integrity protection information storage unit 260 is illustrated as not being included in the electronic data integrity protection device 140, it may alternatively be included in the electronic data integrity protection device 140.

Furthermore, the electronic data integrity protection device 140 may optionally further include a data integrity verification unit (not shown) which may be configured to verify the electronic data with the integrity protection information generated by the integrity protection operation unit 250. Verification with the integrity protection information may include real-time verification of a stream of electronic data and verification of stored electronic data dependent upon a specific application scenario.

According to a specific embodiment of the invention, the integrity protection mode may include, but not limited to, digital watermark, digital digest, digital signature, timestamp, etc. An integrity protection mode of variable integrity protection parameters may be adopted, and a specific protection mode may be selected for use and the extent of electronic data integrity protection may be changed according to the external signal. A normal electronic data integrity protection mode to an enhanced electronic data integrity protection mode may be available by modifying integrity protection parameters. The specific integrity protection parameters may be selected by default or customized by the user or acquired from statistical learning. The integrity protection mode of variable integrity protection parameters may include one or more of the following modes:

a data integrity protection mode of variable granularity: electronic data is firstly divided into blocks and then an integrity operation is performed on the blocks of data. A smaller block length, i.e., a fine granularity may facilitate the precision of data integrity protection, and a larger block length, i.e., a coarse granularity may facilitate the efficiency of computation. The block length, i.e., the granularity, is a variable integrity protection parameter;

a data integrity protection mode of variable redundancy: the integrity protection information resulting from integrity calculation on the blocks of electronic data may include both integrity protection information of the current data block and integrity protection information of the preceding data blocks. That is, integrity protection information of the respective data blocks may be stored redundantly in the resulting integrity protection information. The redundancy is a variable integrity protection parameter;

a data integrity protection mode with forward electronic data protection of variable time: when an abnormal signal occurs, previously generated electronic data is often also important to analyze the reason of the occurring abnormal signal in addition to data at a current moment of time. Data integrity protection of forward electronic data is initiated or enhanced when the external signal is transmitted. In addition to protection of the current electronic data, electronic data in a period of time prior to transmission of the external signal is retrieved from the electronic data storage unit, and data integrity protection is performed also on this data. Protection of the data prior to transmission of the external signal may be enhanced with a longer forward time. The length of the forward time of the forward data is a variable integrity protection parameter;

a hierarchal data integrity protection mode: some key information often exists in the electronic data, and protection of such crucial information shall be particularly enhanced when an external signal occurs. Also when an abnormal event occurs, hierarchal protection of the electronic data may play a role of redundant backup. For example, video data may be divided into multiple levels of video digest, key feature, key frame, all frames, etc. Integrity protection of data at an important level may be initiated or enhanced when the external signal is transmitted. Data at the different levels may be extracted and the importance of the respective levels may be defined variously; and

a data integrity protection mode wherein an interval between timestamp requests is variable: a different interval between timestamp requests may be adopted dependent upon the presence or absence of the external signal or its specific type. For example, when the external signal is transmitted, a timestamp request is transmitted immediately to protect the current data, and the interval between timestamp requests of the subsequent data blocks is shortened. When there is no external signal, electronic data integrity may be protected without any timestamp request or through appending a timestamp to electronic data at a longer interval. When data integrity protection is performed on data between the timing when a preceding timestamp is received and that when a latter timestamp is received, information on the preceding timestamp will be appended.

It shall be noted here that the electronic data integrity protection device 140 illustrated in FIG. 2 and the structures of its constituent units are merely exemplary, and those skilled in the art may modify the structural block diagram illustrated in FIG. 2 as needed.

The electronic data integrity protection device according to the embodiment of the invention may be applied in a video monitoring system and may be trigged by an alarming module to protect video data integrity. The involved objects include a monitoring camera, a video data server and an alarming interface of a monitoring system. However, those skilled in the art shall appreciate that an application of the invention apparently should not be limited to a video monitoring system.

In order to illustrate the technical solution of the invention more clearly, an application scenario of the invention will be introduced below taking a video monitoring system as an example. For example, with respect to a building security monitoring system, 24-hour monitoring of a building is taken as an example. A flow of crowds at the entrance to the building, a flow of vehicles in front of the building and situations in respective major passages in the building are monitored respectively. When the security monitoring system is initialized, an initialization signal is transmitted to start an electronic data integrity protection device with normal integrity protection. In the process of monitoring, a monitoring camera at a certain site detects an abnormal event and is trigged by an abnormality alarming signal to initiate enhanced integrity protection, thereby performing enhanced protection of real-time data prior to and after the occurrence of the abnormal event. In the off-work rush hour, both the flow of crowds at the entrance to the building and the flow of vehicles in front of the building are large, so monitoring cameras at the entrance to the building and in front of the building are triggered by a timing signal to initiate enhanced integrity protection. In the night, enhanced security monitoring is required in the building, and all of the monitoring cameras are started for enhanced integrity protection, and redundant protection of video data integrity is enhanced, so that a requirement for checking the recorded monitoring video may be satisfied to the greatest extent even if part of data is corrupted.

A process of computing integrity protection information will be introduced below taking video data integrity as an example. However, those skilled in the art shall appreciate that the following process is merely exemplary and the invention should not be limited thereto.

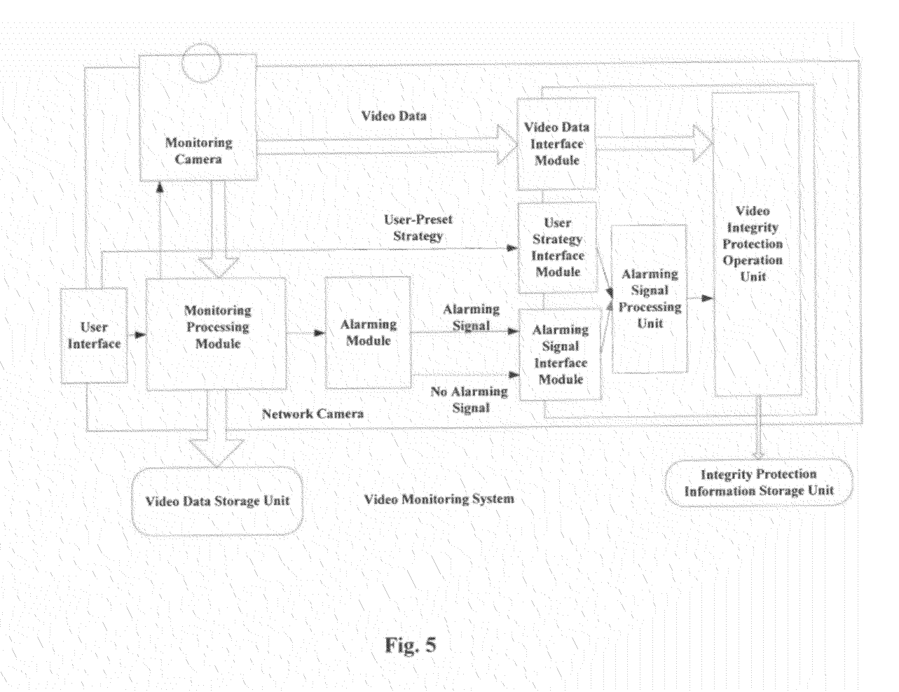

Firstly, an original video is preprocessed. The data is divided into levels. The levels may include video segment, group of pictures and frame. Alternatively, the levels may include all frames, key frame, key feature, video digest, etc. FIG. 5 illustrates a schematic diagram of levels of data. The data at the different levels is divided into blocks. Multiple video segments, groups of pictures or frames may be combined into a data block.

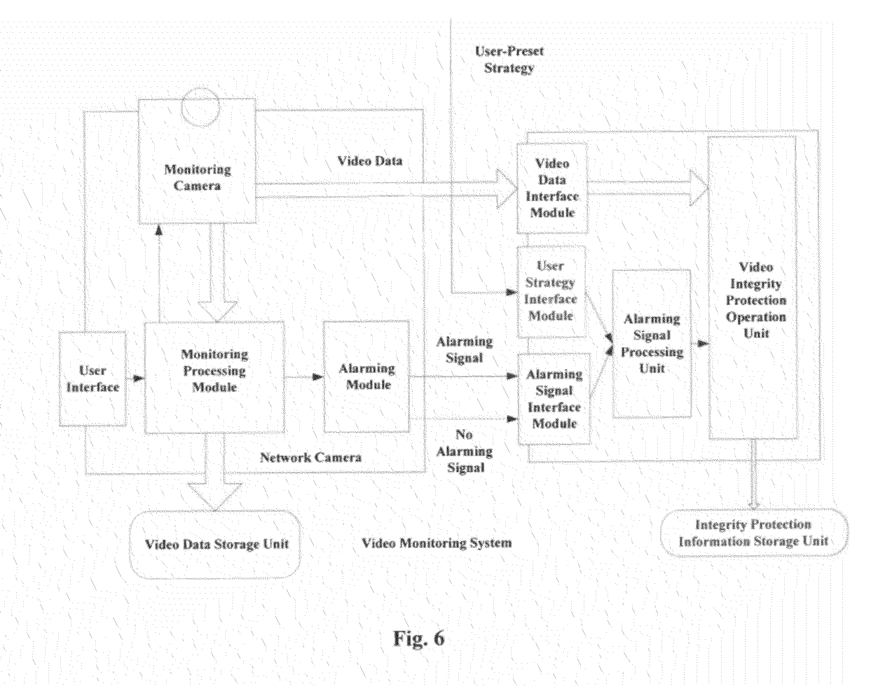

Secondly, integrity protection information is computed respectively in a variety of methods. FIG. 6 illustrates a general block-wise iterative computation method. Block-wise iterative computation hashing is performed on the data blocks. Hash values of the respective data blocks will be involved in hash computation of the subsequent data blocks. The respective hash values of the multiple blocks of data are digitally signed, and a timestamp is appended to the digital signatures and the corresponding hash values for verification. The computed hash values, the digital signature and the timestamps together compose integrity protection information.

Finally, the integrity protection information may be stored in various ways. In one way, it may be appended into head information of the original video data. Alternatively, it may be added into a new layer combined with the original video data in a video container. Also, the integrity protection information may be stored in the integrity information storage unit. A storage space required for storage of the integrity protection information is smaller than that for storage of a large volume of video data. Integrity protection information generated when an alarming signal is transmitted may be stored in a dedicated storage unit.

An enhanced integrity protection mechanism upon alarming may be available by modifying the integrity protection parameters of the integrity protection mode to accommodate a specific scenario and requirement upon alarming.

When an alarming signal is transmitted, video data prior to transmission of a video monitoring alarming signal, which tends to be important to analyze an alarm event, shall be particularly protected in addition to immediate protection of the current data. In addition to protection of the current electronic data, electronic data in a period of time prior to transmission of the external signal is retrieved from the electronic data storage unit, and data integrity protection is performed also on this data. Protection of the data prior to transmission of the external signal may be enhanced with a longer forward time.

When an alarming signal is transmitted, protection of the data at the key levels of video digest, key feature, key frame, etc., may be enhanced while modifying the integrity protection parameters of granularity to a fine granularity to thereby improve the precision of data integrity protection.

Also, the monitoring system tends to be subject to an abnormality or an attack when an alarming signal is transmitted. Thus, there is a larger risk of losing video data acquired by a monitoring camera. The integrity protection information resulting from integrity computation on the blocks of electronic data may include integrity protection information of both the current data block and the preceding data blocks. That is, integrity protection information of the respective data blocks may be stored redundantly in the resulting integrity protection information.

When an alarming signal is transmitted, real-time protection of the current video data is initiated, which requires immediate transmission of a timestamp request to protect the current data and an interval between timestamp requests of subsequent data blocks is shortened. When data integrity protection is performed on data between the timing when a preceding timestamp is received and that when a latter timestamp is received, information on the preceding timestamp will be appended.

Furthermore, the electronic data integrity protection device according to the embodiment of the invention may be applied in a video monitoring system in the following ways:

In a first online way, an integrity protection operation is performed by a network camera. A video encoder of the network camera stores encoded video data in a data buffer. A Central Processing Unit (CPU) or a built-in dedicated chip in the network camera is responsible for an integrity protection operation. Data resulting from the operation is stored in the integrity protection information storage unit. The integrity protection information storage unit is implemented by a data server in the monitoring server. Upon reception of an alarming signal, the CPU or the built-in dedicated chip in the network camera is responsible for initiating an enhanced integrity protection operation, and data resulting from the operation is stored in the integrity protection information storage unit. The architecture of this implementation is as illustrated in FIG. 5.

In a second centralized processing way, an integrity protection operation is performed by a dedicated device. The dedicated device is responsible for listening to an alarming signal after the network camera acquires video data, and initiating a corresponding integrity protection operation in response to the alarming signal. In this way, there is no extra consumption of any resource and operation capability of the network camera. The dedicated device may be connected with multiple network cameras to perform an integrity protection process depending upon the operation capability thereof. The architecture of this implementation is as illustrated in FIG. 6.

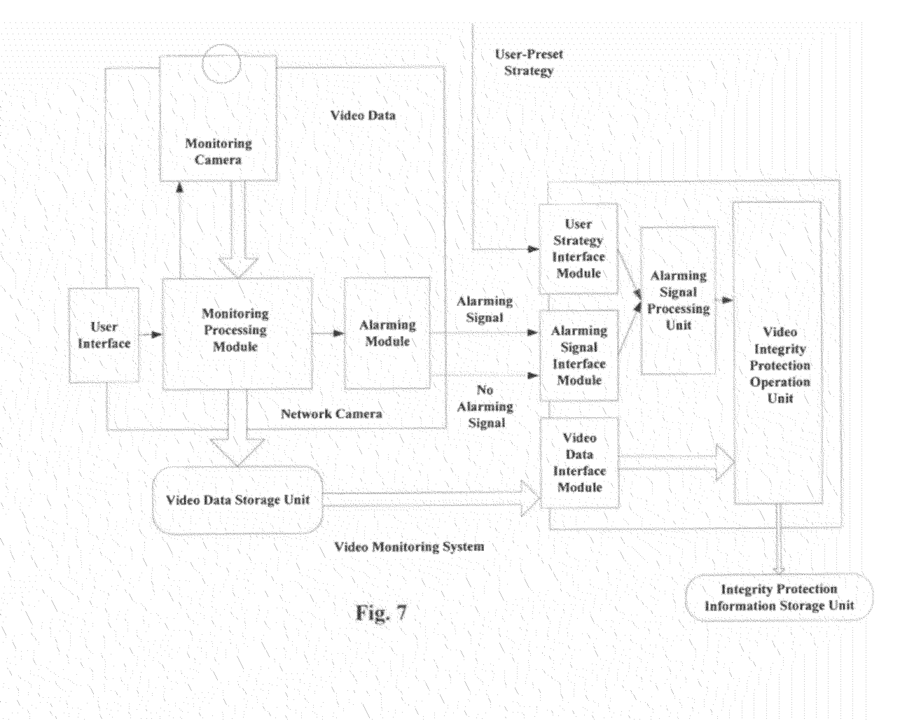

In a third offline way, the network camera stores encoded video data in a data server. The alarming signal interface module is responsible for receiving an alarming signal, retrieving the video data from the data server through a video data interface module and starting a video data integrity protection module to perform an integrity protection operation. The video data integrity protection module may be run directly on the data server or on a separate Personal Computer (PC). Data resulting from the operation is stored in the integrity protection information storage unit. The architecture of this implementation is as illustrated in FIG. 7.

In FIG. 5 to FIG. 7, the vide data interface module corresponds to the data reception unit 210 in FIG. 2, the alarming signal interface module corresponds to the protection strategy configuration unit 230 in FIG. 2, the alarming signal processing unit corresponds to the signal processing unit 240 in FIG. 2, and the video integrity protection operation unit corresponds to the integrity protection operation unit 250.

These three ways may be selected dependent upon an operation capability of the network camera, a specific structure of the monitoring system and a specific requirement of the user.

The electronic data integrity protection device according to the embodiment of the invention has been described in details above with reference to the drawings. An electronic data integrity protection method according to an embodiment of the invention will be described in details below with reference to the drawings.

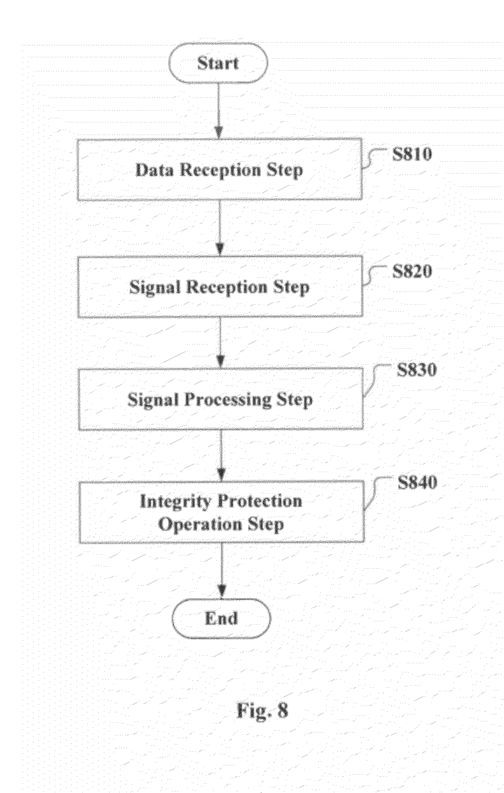

FIG. 8 illustrates a general flow chart of an electronic data integrity protection method according to an embodiment of the invention.

As illustrated in FIG. 8, firstly in the step S810, electronic data to be protected is received.

Next in the step S820, an external signal is received.

Next in the step S830, the external signal is processed in accordance with a predetermined integrity protection strategy, to output a corresponding instruction, wherein the integrity protection strategy specifies at least an integrity protection mode associated with the external signal.

Finally in the step S840, in response to the instruction, a corresponding integrity protection operation is performed on the electronic data, according to the integrity protection mode associated with the external signal, so as to generate integrity protection information of the electronic data.

How to perform the respective steps of the electronic data integrity protection method will become apparent upon reading the foregoing description of the corresponding processes, and therefore a repeated description thereof will be omitted here.

The fundamental principle of the invention has been described above in connection with the embodiments thereof, but it shall be noted that those ordinarily skilled in the art may appreciate that all or any of the steps or components in the method and apparatus according to the invention may be implemented with hardware, firmware, software or a combination thereof in any computing device (including a processor, a storage medium, etc.) or network of computing devices. These steps or components may be implemented by those ordinarily skilled in the art when reading the descriptions of the invention by means of their general programming skills.

Accordingly, the object of the invention may also be attained by running a program or a set of programs on any computing device which may be a well-known general device. Therefore, the object of the invention may also be attained simply by providing a program product containing program codes for implementing the above method or device. In other words, both the program product and a storage medium in which the program product is stored will also constitute the invention. Apparently, the storage medium may be any storage medium well known or to be developed in the future.

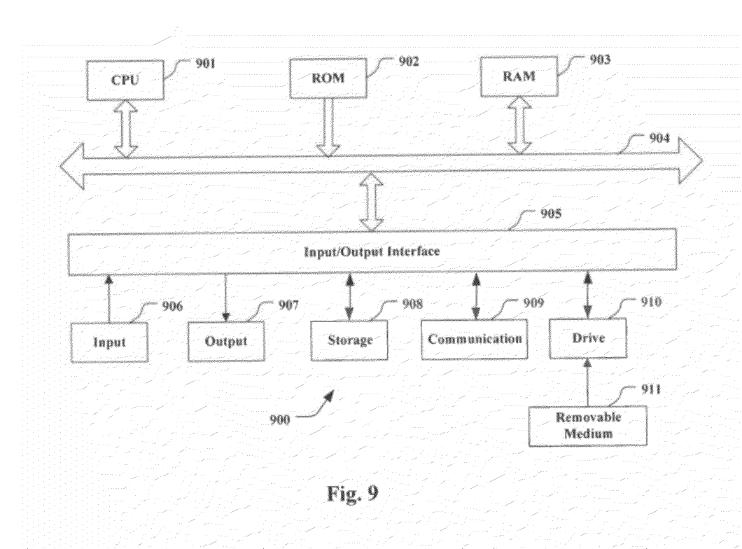

In the case where the above method and device are implemented by software and/or firmware, a program that constitutes the software is installed, from a storage medium or a network, into a computer having a dedicated hardware configuration, e.g., a general-purpose computer 900 as illustrated in FIG. 9, that when various programs are installed therein, becomes capable of performing various functions, or the like.

In FIG. 9, a central processing unit (CPU) 901 performs various processes in accordance with a program stored in a read only memory (ROM) 902 or a program loaded from a storage section 908 to a random access memory (RAM) 903. In the RAM 903, data required when the CPU 901 performs the various processes or the like is also stored as required. The CPU 901, the ROM 902 and the RAM 903 are connected to one another via a bus 904. An input/output interface 905 is also connected to the bus 904.

The following components are connected to input/output interface 905: an input section 906 including a keyboard, a mouse, or the like; an output section 907 including a display such as a cathode ray tube (CRT), a liquid crystal display (LCD), or the like, and a loudspeaker or the like; the storage section 908 including a hard disk or the like; and a communication section 909 including a network interface card such as a LAN card, a modem, or the like. The communication section 909 performs a communication process via the network such as the internet.

A drive 910 is also connected to the input/output interface 905 as required. A removable medium 911, such as a magnetic disk, an optical disk, a magneto-optical disk, a semiconductor memory, or the like, is mounted on the drive 910 as required, so that a computer program read therefrom is installed into the storage section 908 as required.

In the case where the above-described series of processes are implemented by the software, the program that constitutes the software is installed from the network such as the internet or the storage medium such as the removable medium 911.

One skilled in the art should note that, this storage medium is not limit to the removable medium 911 having the program stored therein as illustrated in FIG. 9, which is delivered separately from the device for providing the program to the user. Examples of the removable medium 911 include the magnetic disk (including a floppy disk (register trademark)), the optical disk (including a compact disk-read only memory (CD-ROM) and a digital versatile disk (DVD)), the magneto-optical disk (including a mini-disk (MD) (register trademark)), and the semiconductor memory. Alternatively, the storage medium may be the ROM 902, the hard disk contained in the storage section 908, or the like, which have the program stored therein and is delivered to the user together with the device that containing them.

It should also be noted that, obviously, in the device and method of the present invention, respective components or steps can be decomposed and/or recombined. These decomposition and/or recombination should be regarded as equivalent solutions of the invention. Further, the step in which the above-described series of processes are performed may naturally be performed chronologically in order of description but needed not be performed chronologically. Some steps may be performed in parallel or independently of one another.

Although the invention and the advantages thereof have been described in details, it should be understood that various modifications, substitutions and variations may be made therein by one skilled in the art without departing from the scope or spirit of the invention. Furthermore, the terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

What is claimed is:

1. An electronic data integrity protection device, comprising:
a data reception unit configured to receive electronic data to be protected;
a signal reception unit configured to receive an external signal;
a signal processing unit configured to process the external signal received by the signal reception unit in accordance with a predetermined integrity protection strategy, to output a corresponding instruction, wherein the integrity protection strategy specifies at least an integrity protection mode associated with the external signal; and
an integrity protection operation unit configured to perform, in response to the instruction output by the signal processing unit, a corresponding integrity protection operation on the electronic data received by the data reception unit, according to the integrity protection mode associated with the external signal, so as to generate integrity protection information of the electronic data.

2. The electronic data integrity protection device as claimed in claim 1, further comprising a protection strategy configuration unit configured to configure the integrity protection strategy.

3. The electronic data integrity protection device as claimed in claim 1, wherein the electronic data includes video, audio, image and text.

4. The electronic data integrity protection device as claimed in claim 1, wherein the external signal includes a real-time abnormal alarming signal, a scene change signal, a specific time signal and a user-triggered signal.

5. The electronic data integrity protection device as claimed in claim 1, wherein the integrity protection operation comprises digital watermark, digital digest, digital signature and timestamp.

6. The electronic data integrity protection device as claimed in claim 1, further comprising an integrity protection information storage unit configured to store the integrity protection information generated by the integrity protection operation unit.

7. The electronic data integrity protection device as claimed in claim 1, wherein the integrity protection mode is at least one of the following modes:
a data integrity protection mode of variable granularity;
a data integrity protection mode of variable redundancy;
a data integrity protection mode with forward electronic data protection of variable time;
a hierarchical data integrity protection mode; and
a data integrity protection mode wherein an interval between timestamp requests is variable.

8. An electronic data integrity protection method, comprising:
receiving electronic data to be protected;
receiving an external signal;
processing the external signal in accordance with a predetermined integrity protection strategy, to output a corresponding instruction, wherein the integrity protection strategy specifies at least an integrity protection mode associated with the external signal; and
performing, in response to the instruction, a corresponding integrity protection operation on the electronic data, according to the integrity protection mode associated with the external signal, so as to generate integrity protection information of the electronic data.

9. The electronic data integrity protection method as claimed in claim 8, wherein the integrity protection strategy is configurable.

10. The electronic data integrity protection method as claimed in claim 8, wherein the electronic data includes video, audio, image and text.

11. The electronic data integrity protection method as claimed in claim 8, wherein the external signal includes a real-time abnormal alarming signal, a scene change signal, a specific time signal and a user-triggered signal.

12. The electronic data integrity protection method as claimed in claim 8, wherein the integrity protection operation includes digital watermark, digital digest, digital signature and timestamp.

13. The electronic data integrity protection method as claimed in claim 8, further comprising: storing the integrity protection information.

14. The electronic data integrity protection method as claimed in claim 8, wherein the integrity protection mode is at least one of the following modes:
a data integrity protection mode of variable granularity;
a data integrity protection mode of variable redundancy;
a data integrity protection mode with forward electronic data protection of variable time;
a hierarchical data integrity protection mode; and
a data integrity protection mode wherein an interval between timestamp requests is variable.

15. A data monitoring system, comprising:
a data capturing device configured to capture electronic data to be protected;
a control center configured to send a control signal used to initiate or enhance electronic data integrity protection;
an electronic data integrity protection device configured to initiate or enhance, in response to the control signal, electronic data integrity protection for the electronic data, wherein the electronic data integrity protection device comprising,
a data reception unit configured to receive the electronic data,
a signal reception unit configured to receive the control signal,
a signal processing unit configured to process the control signal in accordance with a predetermined integrity protection strategy, to output a corresponding instruction, wherein the integrity protection strategy specifies at least an integrity protection mode associated with the control signal, and
an integrity protection operation unit configured to perform, in response to the instruction output by the signal processing unit, a corresponding integrity protection operation on the electronic data, according to the integrity protection mode associated with the control signal, so as to generate integrity protection information of the electronic data.

16. The data monitoring system as claimed in claim 15, further comprising a data storage device configured to store the electronic data captured by the data capturing device.

17. A program product with machine readable instruction codes stored thereon, which, when being read and executed by a machine, performs an electronic data integrity protection method, wherein the electronic data integrity protection method comprises steps of:
receiving electronic data to be protected;
receiving an external signal;
processing the external signal in accordance with a predetermined integrity protection strategy, to output a corresponding instruction, wherein the integrity protection strategy specifies at least an integrity protection mode associated with the external signal; and
performing, in response to the instruction, a corresponding integrity protection operation on the electronic data, according to the integrity protection mode associated with the external signal, so as to generate integrity protection information of the electronic data.

18. A storage medium carrying thereon the program product according to claim 17.
